(19) United States
(12) Patent Application Publication
(10) Pub. No.: US 2016/0137472 A1
(43) Pub. Date: May 19, 2016

(54) MACHINE AND METHOD FOR FILLING CONTAINERS AND CLEANING METHOD

(71) Applicant: KHS GMBH, Dortmund (DE)

(72) Inventors: Thomas Niehr, Bad Münster am Stein Ebernburg (DE); Jürgen Vorwerk, Mönsdorf (DE); Andreas Lörcks, Oer-Erkenschwick (DE)

(21) Appl. No.: 14/772,534

(22) PCT Filed: Jan. 28, 2014
(86) PCT No.: PCT/EP2014/000208

§ 371 Date: Sep. 3, 2015

(30) Foreign Application Priority Data
Mar. 8, 2013 (DE) 10 2013 003 931.2

(51) Int. Cl. B67C 3/22

(52) U.S. Cl. CPC B67C 3/22; B67C 2003/228

(57) ABSTRACT

A filling machine includes a rotor, a rotor bearing that rotatably mounts the rotor on the machine-frame for rotation about a machine axis, and filling elements disposed on the rotor. Each filling element, together with a container carrier, defines a filling point. The machine includes a filling-material boiler arranged on the rotor and configured to rotate with the rotor, as well as a boiler-cover connected to the machine-frame and configured to not rotate with the rotor, and a seal. The seal seals a transition between the boiler cover and the filling-material boiler.

The invention relates to a filling machine according to the preamble of claim 1, to a method for filling containers according to the preamble of claim 11, and to a method for cleaning and/or sterilising the filling machine according to the preamble of claim 13.

A filling machine with the features of the preamble of claim 1 is known in principle (U.S. Pat. No. 2,638,259). The known filling machine is one of rotating design with a rotor driven in rotation about a vertical machine axis, with a plurality of filling points on the periphery of this rotor. A co-rotating filling material boiler is provided on the rotor, with which the filling elements arranged below the boiler are in connection at the filling points. To close the boiler interior, on the top of the boiler a cover is firmly connected to the boiler. To supply the liquid filling material to the filling material boiler, a product connection is provided which is arranged coaxially with the rotor axis but not co-rotating with the rotor, and which opens into the upper region of the boiler interior.

A filling machine of rotating design is also known (DE 25 53 989 A1) in which a further filling material boiler is provided on a rotor rotating about a vertical machine axis, in addition to a filling material boiler formed as a ring boiler common to all filling elements of the filling machine; this further boiler is connected to the ring boiler and arranged with its axis coaxial to the vertical machine axis of the filling machine. A product supply not co-rotating with the rotor opens into this further filling material boiler coaxially with the machine axis. The rotary connection normally provided in filling machines of rotating design, which serves to supply the liquid filling material from an external product line to the rotor or the filling material vessel there, is not required.

The object of the invention is to provide a filling machine which, with simplified constructional design and high operating reliability, in particular allows a simplified but nonetheless optimum cleaning and/or disinfection of all regions coming into contact with the filling material, and in particular also the filling material boiler. To achieve this object, a filling machine is formed according to claim 1. A method for filling containers is the subject of claim 10. A method for cleaning and/or sterilising the filling machine is the subject of claim 11.

In the invention, there is no need for the rotary connection for supplying liquid filling material to the rotor, as usually provided in the filling machine of rotating design. This substantially simplifies the construction, not only by the omission of the normal rotary passage but also by the reduction of the piping complexity and the necessary rotating seals.

In the filling machine according to the invention, only the filling material boiler is configured to co-rotate with the rotor, while the cover does not rotate with the rotor, i.e. it is firmly held on the machine frame. The transition between the cover and the filling material boiler is sealed by at least one seal against the ingress of substances, media and in particular bacteria from the outside into the interior of the filling material boiler, so that the filling machine is also suitable as an aseptic machine, i.e. a filling machine for aseptic filling of material into the container. By sealing the transition between the filling material boiler and the cover, it is furthermore possible to pressurise the gas chamber, formed above the filling material level in the partially filled boiler during filling operation, with an inert gas under pressure, for example with sterile air, nitrogen or CO₂ gas under pressure, in order thus to securely prevent the ingress of germs or foreign bodies.

The filling machine according to the invention can be used for widely varying filling processes, for example also for pressureless filling of containers, wherein the gas chamber formed in the filling material boiler is then preferably only pressurised with a slight positive pressure, for example a positive pressure of around 40 mbar up to 60 mbar, preferably with a positive pressure of around 50 mbar, but also pressure-filling of the containers when the gas chamber in the filling material boiler is pressurised with a correspondingly higher pressure.

Due to the configuration according to the invention, simplified cleaning and/or disinfection of the filling machine, and in particular of the filling material boiler, is possible with high quality and certainty. In particular for aseptic machines, the configuration according to the invention constitutes a safety bonus since risky areas are minimised.

On cleaning and/or disinfection, e.g. CIP cleaning and/or disinfection, the corresponding medium (including for example hot water vapour) is supplied preferably via a connection which opens tangentially into the filling material boiler interior relative to the vertical machine axis and is provided on the cover, so that in the interior of the filling material boiler, a circulating flow of the cleaning and/or disinfection medium about the machine axis is formed which leads to intensive cleaning and/or disinfection. On cleaning and/or disinfection, suitably a rotary and/or swivel movement is performed relative to the connection or the cover or cover part facing the connection and the filling material boiler about the machine axis.

In one embodiment of the invention, the filling elements are connected to the filling material boiler via product lines. In a further preferred embodiment, the filling material boiler forms a buffer tank which then in turn is connected with a further product boiler, formed for example as a ring boiler, to which the filling elements are connected.

The expression “substantially” or “approximately” in the sense of the invention means deviations from the precise value by +/−10%, preferably by +/−5%, and/or deviations in the form of changes insignificant to function.

Refinements, advantages and possible applications of the invention arise from the description below of exemplary embodiments and from the figures. All features described and/or shown in the figures are in principle the subject of the invention, either alone or in any combination, irrespective of their summary in the claims or back reference. The content of the claims is also made a constituent part of the description.

The invention is explained in more detail below with reference to the figures showing exemplary embodiments. These show:

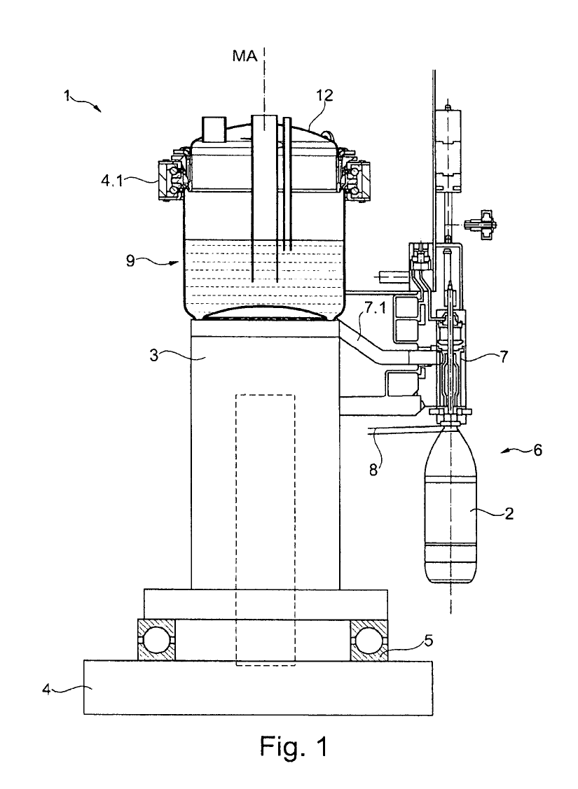

FIG. 1 in simplified diagrammatic view, a filling machine of rotating design for filling containers in the form of bottles with a liquid filling material;

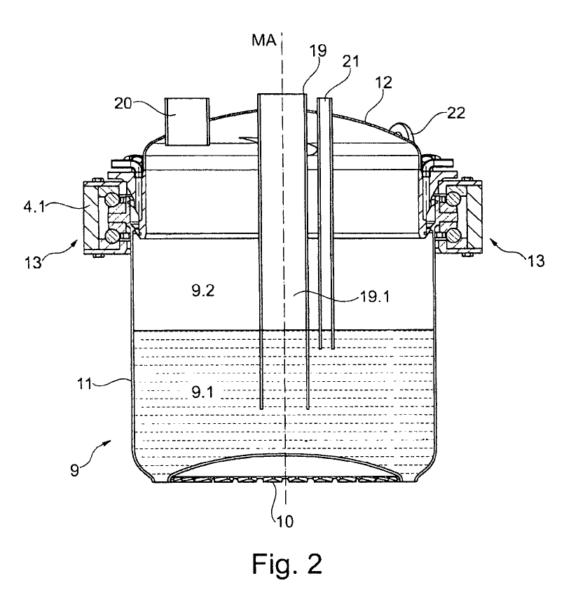

FIG. 2 in enlarged individual depiction and in cross section, the filling material boiler of the filling machine of FIG. 1;

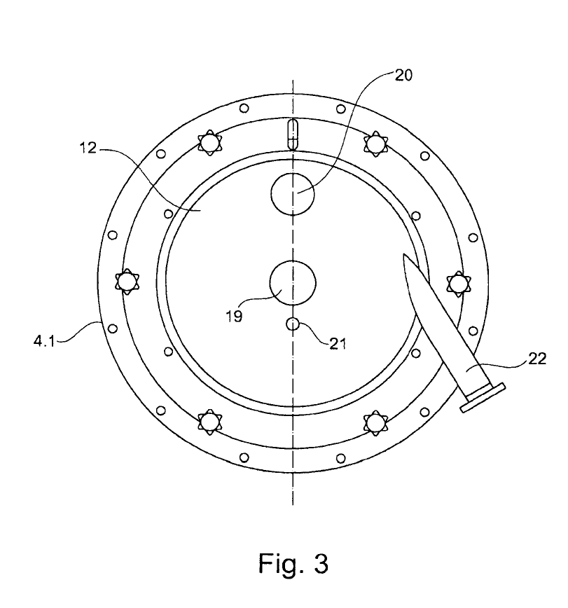

FIG. 3 a top view of the filling material boiler of the filling machine in FIG. 1;

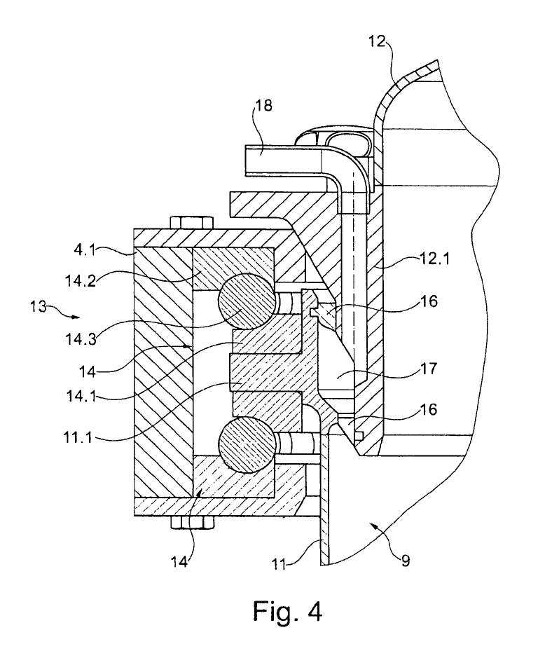

FIG. 4 in enlarged individual depiction, the mounting between the filling material boiler and the cover of the filling machine in FIG. 1;

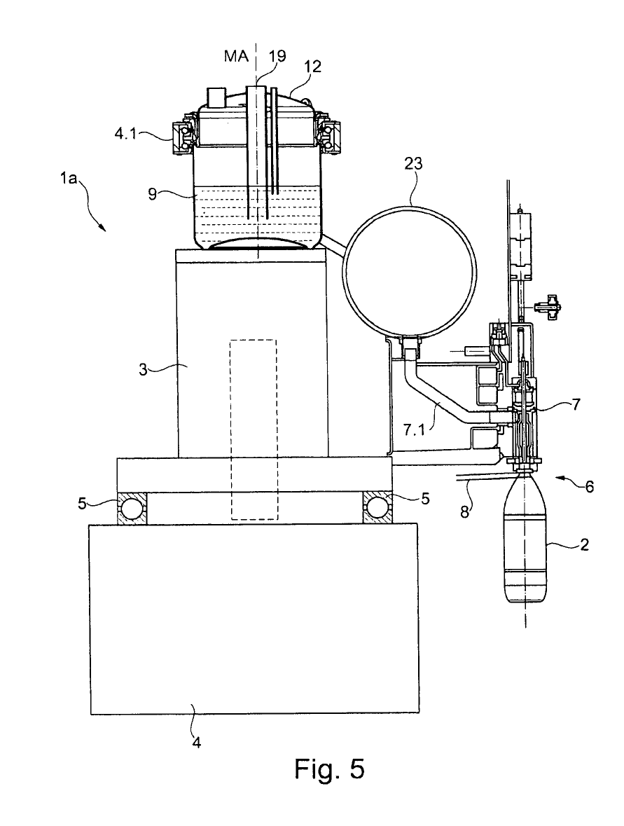

FIG. 5 in simplified diagrammatic depiction, a filling machine of rotating design for filling containers in the form of bottles with a liquid filling material, according to a further embodiment.

The filling machine designated generally as 1 in FIG. 1 serves for filling containers in the form of bottles 2 with a liquid filling material or product, in particular beverages, and is formed as a filling machine of rotating design. For this, the filling machine 1 has a rotor 3 which is rotatably mounted on a machine frame 4 via a rotor bearing 5, indicated merely diagrammatically in FIG. 1 (e.g. a ball bearing slewing guide), about the vertical machine axis MA and which is driven in rotation during the filling operation.

On the periphery of the rotor 3, at even angular distances and at the same radial distance from the machine axis MA, filling points 6 are formed which each have a filling element 7 and a container carrier 8, at which during filling the respective bottle 2 is held suspended, namely with its bottle mouth at a discharge opening of the filling element 7 and with its bottle axis parallel to machine axis MA. A filling material boiler 9 common to all filling elements 7 of the filling machine 1 is provided on the rotor 3, which boiler is connected to the filling elements 7 via product lines 7.1 and which is partly filled with the liquid filling material during the filling operation, so that a lower liquid chamber 9.1 containing the filling material and above this a gas chamber 9.2 are formed in the boiler. To prevent the ingress of foreign bodies and/or bacteria into the filling material boiler 9, the filling machine 1 is in principle operated so that the gas chamber 9.2 filled with an inert gas, for example CO₂ gas, sterile air or nitrogen, always has a certain positive pressure, for example a positive pressure of 40 mbar to 60 mbar.

In the embodiment shown, the filling material boiler 9 is designed cup-like, rotationally symmetrical to the machine axis MA, i.e. with a boiler base 10 and a circular cylindrical or substantially circular cylindrical boiler wall 11. The filling material boiler 9 is also arranged with its axis coaxial with the machine axis MA. On the top, the filling material boiler 9 is closed by a cover 12 which, in contrast to the filling material boiler, does not co-rotate about the machine axis MA with the rotor 3 but is connected to the machine frame 4 or a part or ring 4.1 of the machine frame 4, for example via a torque pick-up.

The figures furthermore show a bearing arrangement 13 to which the filling material boiler 9 is rotatably connected in the region of its top via the cover 12 and the ring 4.1 of the machine frame 4, wherein the actual mounting of the rotor 3 and hence the filling material boiler 9 takes place via the rotor bearing 5.

As FIG. 4 shows, the bearing arrangement 13 comprises, amongst others, an upper and a lower ball bearing slewing ring 14, each of which consists of a boiler-side raceway 14.1 which lies on an annular flange 11.1 protruding radially beyond the outer face of the boiler wall 11, a raceway 14.2 provided on the ring 4.1, and a plurality of balls arranged between these two rings.

It is of particular importance that the transition between the filling material boiler 9 which co-rotates with the rotor 3, and the cover 12 which is fixedly connected to the machine frame 4, is tightly sealed so that the interior of the filling material boiler 9 is hermetically sealed towards the outside, preventing amongst others the ingress of bacteria into the filling material and also allowing a positive pressure in the filling material boiler 9. Furthermore, by sealing the transition between the filling material boiler 9 and the cover 12, optimally cleaning and/or disinfection, in particular CIP cleaning and/or disinfection, and cleaning and/or disinfection under pressure is possible, for example with a positive pressure of up to 3.5 bar.

As FIG. 4 shows, the cover 12 in the region of its cover edge is formed with a circular cylindrical cover portion 12.1 protruding into the filling material boiler 9. Two ring seals 16 are provided between this cover portion and the inner face of the filling material boiler 9, concentrically surrounding the machine axis MA. These are radially offset to each other relative to the machine axis MA and each lie against the inner face of the filling material boiler 9 and the outer face of the cover portion 12.1, such that the ring seals 16 not only seal the transition or gap between the filling material boiler 9 and the cover portion 12.1, but also form an annular chamber 17 surrounding the machine axis MA which is closed by the two ring seals 16 and by the inner face of the filling material boiler 9 and the outer face of the cover portion 12.1. In filling operation, this ring chamber 17 serves as a protective chamber which can be pressurised, via a connection 18 formed in the cover 12, with a protective gas or inert gas under a slight positive pressure, e.g. with sterile air, nitrogen or CO₂ gas, in order to prevent optimally the penetration of foreign bodies, in particular bacteria, from the environment into the interior of the filling material boiler 9.

Various connections are provided on the cover 12 which are sealed and passed through the cover 12, in particular a product connection 19 which in the embodiment shown is formed by a tubular piece 19.1 open at both ends and arranged coaxial with the machine axis MA, the lower end of which extends into the fluid chamber 9.1 so that the filling material boiler 9 is filled with the product from below the surface. This product connection 19, which also does not co-rotate with the rotor 3 and the filling material boiler 9, is connected to an external line for the supply of filling material.

Also provided on the cover 12 are a connection 20 for the supply and discharge of further media, for example for the supply of inert gas into the gas chamber 9.2, a connection 21 formed as a riser pipe, and above all also a tangential connection 22 which opens tangentially or substantially tangentially into the boiler interior relative to the machine axis MA, and which is used for supply of a liquid and/or gaseous and/or vapour cleaning medium on CIP cleaning and/or sterilisation of the filling material boiler 9 and filling machine 1.

On cleaning and/or sterilisation (e.g. CIP cleaning and/or sterilisation), the cleaning medium is introduced via the tangential connection 22, so that in particular the entire inner face of the filling material boiler can be optimally treated with this medium. Due to the tangential supply of the cleaning and/or disinfection media, at least some of the spray heads arranged inside the filling material boiler 9 may be omitted since the tangential inflow of the cleaning and/or disinfection medium leads to the creation of a circular flow in the filling material boiler 9, which intensifies the cleaning and/or sterilisation of the filling material boiler. This particular method of cleaning and/or sterilisation of the rotor-side filling material boiler is possible only because of the configuration of the filling machine 1 described, i.e. because the cleaning and/or sterilisation medium is introduced directly into the filling material boiler 9 via the tangential connection 22.

It is been assumed above that the filling material boiler 9 is the only filling material boiler common to all filler elements 7 of the filling machine 1. FIG. 5 shows as a further embodiment of the invention a filling machine 1a in which the filling material boiler 9 is indeed provided on the rotor 3, but in addition to a ring boiler 23 which is connected to the filler elements 7 via the product lines 7.1. The filling material boiler 9 in this embodiment serves as a rotor-side buffer tank for the filling material, and is connected to the ring boiler 23 common to the filling elements 7 via one or more product lines.

The invention has been described above with reference to exemplary embodiments. Evidently numerous changes and derivations are possible without leaving the inventive concept on which the invention is based.

In particular, it is possible to create the seal between the filling material boiler 9 and cover 12 with only one ring seal surrounding the machine axis MA or with more than two ring seals. Furthermore, the bearing between the filling material boiler 9 and cover 12, or the part of the machine frame 4 carrying this cover, may also be implemented differently from the manner described, for example with just one ball bearing slewing guide 14.

It is also possible to configure the filling machine and/or the filling method such that the product to be filled has no contact with the seal provided for sealing a gap between a mobile part of the filling machine 1, 1a and an immobile part of the filling machine 1, 1a. This quite advantageous embodiment reliably prevents any abraded material from the corresponding seals from entering the filling material.

It is also possible to configure the filling machine 1, 1a so that the cover 12 is mounted rotationally centrally, fixedly above the rotating rotor, and the construction is configured such that the bearing of the filling machine consists solely of the rotor bearing, whereby no additional ball bearing slewing ring is necessary. This quite advantageous embodiment further reduces the mechanical and structural complexity, and finally the cost of a filling machine according to the invention.

### LIST OF REFERENCE NUMERALS

1, 1a Filling machine

2 Bottle

3 Rotor

4 Machine frame

4.1 Part of machine frame 4

5 Rotor bearing

6 Filling point

7 Filling element

8 Container carrier

9 Filling material boiler

10 Boiler base

11 Boiler wall

11.1 Flange

12 Cover

12.1 Cover portion

13 Bearing arrangement

14 Ball bearing slewing ring

14.1, 14.2 Raceway

14.3 Ball

16 Ring seal

17 Chamber

18 Connection

19 Product connection

19.1 Pipe piece

20-22 Connection

23 Ring boiler

MA Machine axis

1-13. (canceled)

14. An apparatus for filling containers with liquid filling-material, said apparatus comprising a filling machine, said filling machine comprising a rotor, a rotor bearing, a machine-frame, filling elements, container carriers, filling points, a container infeed, a container outfeed, a first filling-material boiler, a boiler-cover, a product connection, and a seal, wherein said rotor bearing rotatably mounts said rotor on said machine-frame for rotation about a machine axis, wherein said filling elements are disposed on said rotor, wherein one of said filling elements and one of said container carriers forms one of said filling points, wherein containers to be filled are provided at said container infeed, wherein filled containers are removed from said outfeed, wherein, during filling, said container carriers carry said containers at an angle such that a container axis is parallel to said machine axis, wherein said containers are filled within a range of angles on said rotor between said container infeed and said container outfeed, wherein said first filling-material boiler is arranged on said rotor, wherein said first filling-material boiler rotates with said rotor, wherein said boiler-cover closes said first filling-material boiler, wherein said boiler-cover connects to said machine-frame, wherein said boiler-cover does not rotate with said rotor, wherein said product connection supplies liquid filling-material into said first filling-material boiler, and wherein a seal is disposed to seal a transition between said boiler-cover and said first filling-material boiler.

15. The apparatus of claim 14, further comprising a bearing arrangement, wherein said bearing arrangement is disposed between said first filling-material boiler and said boiler-cover.

16. The apparatus of claim 14, further comprising a bearing arrangement, wherein said bearing arrangement is disposed between said first filling-material boiler and a part of said machine-frame, wherein said part of said machine-frame carries said cover.

17. The apparatus of claim 15, wherein said bearing arrangement comprises a ball-bearing slewing-ring.

18. The apparatus of claim 16, wherein said bearing arrangement comprises a ball-bearing slewing-ring.

19. The apparatus of claim 14, wherein said first filling-material boiler comprises a fluid chamber, and wherein said product connection opens into said fluid chamber.

20. The apparatus of claim 14, wherein said seal comprises a first ring-seal, a first ring-face, a second ring-face, an inner face, and an outer face, wherein said first ring-face is a ring face on said first filling-material boiler, wherein said second ring-face is a ring face on said boiler-cover, wherein said first ring-seal lays against said first ring-face and said second ring-face, wherein said first ring-face is disposed opposite said second ring-face, wherein said inner face comprises an inner face of said first filling-material boiler, wherein said inner face forms said first ring-face, wherein said boiler-cover comprises a boiler-cover portion that extends into said first filling-material boiler, and wherein said outer face is an outer face of said boiler-cover portion.

21. The apparatus of claim 20, further comprising a protective chamber, second ring-seal, a gas connection, and a ring chamber, wherein said first and second ring-seals are offset from each other in a direction along said machine axis, wherein said first and second ring-seals cooperate to seal said transition, wherein said ring chamber is disposed between said first and second ring-seals, wherein said gas connection is in fluid communication with said ring chamber to enable pressurization of said ring chamber with gas provided through said gas connection, thereby causing said ring chamber to become said protective chamber.

22. The apparatus of claim 14, further comprising first and second product-lines, wherein said filling elements comprise first and second filling-elements, wherein said first product-line connects said first filling-material boiler to said first filling-element, and wherein said second product-line connects said first filling-material boiler to said second filling-element.

23. The apparatus of claim 14, further comprising a second filling-material boiler, a first product-line, a second product-line, and a buffer tank, wherein said first filling-material boiler defines said buffer tank, wherein said buffer tank connects to said second filling-material boiler, wherein said second filling-material boiler is on said rotor, wherein said filling elements comprise a first filling-element and a second filling-element, wherein said first product line connects said first filling-element to said second filling-material boiler, and wherein said second product line connects said second filling-material boiler to said second filling-element.

24. The apparatus of claim 14, further comprising first and second product-lines, a buffer tank, and a ring boiler disposed on said rotor and connected to said first filling-material boiler, wherein said first filling-material boiler defines said buffer tank, wherein said filling elements comprise first and second filling-elements connected to said ring boiler by said first and second product-lines respectively.

25. The apparatus of claim 14, further comprising a tangential connection into said first filling-material boiler, wherein said tangential connection is oriented to direct flow into said first filling-material boiler at a non-zero angle relative to said machine axis.

26. The apparatus of claim 14, wherein said rotor bearing completely supports said filling machine, thus eliminating a need for an additional ball-bearing slewing-ring, wherein said boiler-cover is mounted to be fixed above said rotor bearing, wherein said cover is mounted such that a center of said cover intersects said machine axis.

27. A method of using a filling machine that includes a rotor, a rotor bearing that rotatably mounts said rotor on a machine-frame for rotation about a machine axis, filling elements disposed on said rotor, each filling element, together with a container carrier that carries containers parallel to the machine axis, defining a filling point, a container infeed that receives container to be filled in said filling machine, a container outfeed that provides filled containers that have been filled by said filling machine, a filling-material boiler arranged on said rotor and configured to rotate with said rotor, a boiler-cover connected to said machine-frame and configured to not rotate with said rotor, a product connection, and a seal, that seals a transition between said boiler cover and said filling-material boiler, said method comprising supplying said liquid filling-material to said filling-material boiler, causing creation of a gas chamber in said filling-material boiler, causing creation of a liquid chamber in said filling-material boiler, said liquid chamber being below said gas chamber, and pressurizing said gas chamber with inert gas to create a positive pressure of between 40 millibars and 50 millibars in said filling-material boiler.

28. The method of claim 27, further comprising keeping said seal free of contact with said liquid-filling material.

29. The method of claim 27, further comprising supplying a medium into said filling-material boiler under pressure through a tangential connection that creates a circular flow of said medium, wherein said pressure is up to 3 bar above atmospheric pressure, and wherein said medium is selected from the group consisting of a cleaning medium and a sterilizing medium.
